(19) United States
(12) Patent Application Publication
(10) Pub. No.: US 2010/0165791 A1
(43) Pub. Date: Jul. 1, 2010

(54) METHOD FOR QUANTITATIVELY MAKING A THICKNESS ESTIMATE OF THIN GEOLOGICAL LAYERS BASED ON SEISMIC REFLECTION SIGNALS IN THE FREQUENCY DOMAIN

(75) Inventor: Espen Oen LIE, Bergen (NO)

Correspondence Address: BIRCH STEWART KOLASCH & BIRCH, PO BOX 747, FALLS CHURCH, VA, 22040-0747, US

(73) Assignee: StatoilHydro ASA, Stavanger (NO)

(21) Appl. No.: 12/554,692

(22) Filed: Sep. 4, 2009

Related U.S. Application Data
(60) Provisional application No. 61/094,742, filed on Sep. 5, 2008.

(51) Int. Cl. G01V 1/00

(52) U.S. Cl. 367/49

(57) ABSTRACT

A method of estimating thickness of a geological layer includes selecting seismic reflection field data from a subsurface depth interval of interest; providing a plurality of geological models having different layer thicknesses and providing respective model responses from the plurality of geological models; comparing a frequency spectrum of the seismic reflection field data with each of the frequency spectra of the model responses to derive comparison data associated with the different layer thicknesses of the models; and deriving from the comparison data a model layer thickness that is indicative of the thickness of the geological layer.

### CROSS-REFERENCE TO RELATED APPLICATIONS

This application claims priority under 35 U.S.C. §119(e) to U.S. Provisional Application No. 61/094,742, filed on Sep. 5, 2008, the entirety of which is expressly incorporated herein by reference.

The present invention relates to a method for quantatively estimating a thickness of a buried geological layer.

The present invention relates generally to a method for making a thickness estimate of a buried geological layer based on seismic reflection data. More specifically, the method relates to estimating the thickness of thin geological layers utilising the reflection signals' frequency domain properties, instead of interpreting thin geological layer thickness based on the time domain signals alone.

### INTRODUCTION

In geophysics it is desirable to interpret geological layer thicknesses. Such thicknesses are usually expressed in either reflection time difference Δt between two-way reflection time between the top and the bottom of the layer

Δt=t_{bottom}−tₜₒₚ

The thicknesses of interest may be either a thickness of a geological layer in a potential or confirmed petroleum reservoir, a thickness of a gas zone in the top of such a petroleum reservoir, an oil zone thickness in a petroleum reservoir, or the thickness of any other geological layer. Finding the thickness of a thick, uniform geological layer is easy from time domain reflection data, simply by picking the top and base reflection when clearly separated, and calculating the time difference.

The problem to be addressed by this invention arises when the thickness of a layer indicated in the seismic data is thin, the layer having a thickness comparable to the so-called tuning thickness, below which the interpreted thickness becomes thicker than the true thickness.

FIG. 1a is an illustration of the tuning effect on the interpretation of thickness. A horizontal geological wedge model as illustrated by the continuous line of FIG. 1a is centered in FIG. 1a on 200 ms two-way reflection time illustrated by its top and bottom reflections. The abscissa indicates the true layer thickness of the model. In FIG. 1b, the thickness from the interpreted data has been overlain on the model. Clearly, for the thicker portions of the wedge, between 25 and 40 ms twt, there is good correspondence between interpreted thickness as illustrated by the dotted line, and true thickness indicated by the continuous line. But for the thinner layers there are two kinds of discrepancies between the interpreted thicknesses and the true thicknesses. This is better illustrated in FIG. 2.

FIG. 2 is a diagram of interpreted layer thickness versus true layer thickness. The interpreted layer thickness as illustrated by the broken line in this diagram is interpreted from two-way time reflection seismic modelled data such as illustrated in FIG. 1a, and the true layer thickness indicated by the continuous line is taken from the wedge model indicated by the continuous wedge lines of FIG. 1b.

In FIG. 2 is better seen that for the thicker portions of the wedge, between 25 and 40 ms twt, there is good correspondence between interpreted thickness as illustrated by the dotted line, and true thickness indicated by the continuous line. But for the thinner layers below 14 ms the interpreted thickness exceeds the true thickness; in fact, the interpreted thickness flattens out to a value of about 11 to 12 ms twt of the layer which actually pinches out to zero true thickness. Further, between 14 and about 28 to 30 ms true layer thickness, the interpreted layer thicknesses are systematically slightly less than the true thicknesses.

The fact that the interpreted layer thicknesses become thicker than the true thicknesses for thin layers may be explained by interference of the reflections. FIG. 3a is an illustration of a very simple geological model with a uniform rock from the surface and down to 0.400 s having an acoustic impedance of 5·10⁶ kg/m²s in which a thin horizontal layer of acoustic impedance of 4·10⁶ kg/m²s resides between 0.176 ms and 0.200 ms for a temporal thickness of 0.024 s. The impedance curve is thus a straight line with a steeply tapered-off negative square pulse. A reflectivity is shown in FIG. 3b as points of 4 ms sampling rate, the reflectivity at the top of the layer at 0.176 s being rₜ=−0.1 and the reflectivity at the bottom of the layer at t=0.200 s being r_{b}=0.1. If these reflectivities are convolved with a digital source wavelet being a 30 Hz Ricker wavelet, the result is displayed in FIG. 3c. (The reflectivities shown here are zero offset, but there is no requirement in the present method to use zero offset data.) Ryan, in the publication “CSEG Recorder”, September 1994, states that an approximation of the Ricker wavelet breadth (in time) is 0.7797/f*1.28, which corresponds to 40 ms. Thus the time difference between the zero time peak and a negative side lobe is 20 ms. This results in possible interference between the side lobes and the main peak for thin layers such as illustrated in FIG. 3c.

A main problem with conventional thickness estimates is that they operate in the time domain. In the time domain, temporal parameters are well resolved, but frequency parameters are not localized in the time domain but are distributed so they may not easily be assessed. When reflections from a top and a base of a layer interfere due to tuning, some frequencies may no longer be represented in the interval. This implies that in the time domain, such frequencies do not contribute to the amplitude of such temporally close reflections. But the fact that some frequencies are missing due to temporally close reflections is not easily observed in the time domain.

However, if we look at the problem in the frequency domain, the problems become more visible. In FIG. 6, the source signature is displayed in the frequency domain as shown in the right portion of the sheet. In the left, main portion of the sheet is shown the frequency spectra of the wedge model of FIG. 1b. FIG. 6 is the general, version of FIG. 3f which correspond to the section through the line for 25 ms layer thickness. Please note the notch at 40 Hz in FIG. 3f and in FIG. 6. FIG. 7 displays the amplitude of the frequency spectra for a pair of reflectivities of opposite sign, such as displayed in FIG. 3b. The vertical section through 25 ms layer thickness of FIG. 7 thus corresponds to FIG. 3e with its 40 Hz, 80 Hz, and 120 hz Notches.

As the graph of FIG. 3f displays the frequency spectrum of the reflectivity displayed in FIG. 3e, multiplied with the frequency spectrum of the 25 Hz Ricker pulse frequency spectrum of the seismic source displayed in FIG. 3d, similarly the frequency domain representation as shown in FIG. 6 of the wedge model displayed in FIG. 1b is the frequency domain interference pattern of opposite reflectors as displayed in FIG. 7 multiplied by the 25 Hz Ricker pulse frequency spectrum of the seismic source displayed in the right portion of FIG. 8.

From FIG. 6 it is obvious that no trace of the frequency domain interference pattern of the opposite seismic impedance reflectors is left above the upper frequencies of the source signature spectrum, i.e. no trace is left above about 70 Hz.

The 30 Hz Ricker wavelet is shown in the frequency domain in FIG. 3d. The reflectivity in the frequency domain is shown in FIG. 3e as a “beat frequency”, here 40 Hz. This reflectivity in the frequency domain multiplied with the 30 Hz Ricker wavelet, also in the frequency domain, provides the data in the frequency domain, please see FIG. 3f. The 40 Hz low is prominent. Please note that the zero amplitude frequency is independent of the Ricker pulse frequency.

### BACKGROUND ART

In U.S. Pat. No. 5,870,691 to Partyka et al., “Spectral decomposition for seismic interpretation”, is presented a problem of finding a temporal thickness of a thin bed, similar to what is the problem to be solved by the present invention. Partyka has solved this in a qualitative way. The spectrum of a thin bed reflection is illustrated in FIG. 3B of U.S. Pat. No. 5,870,691, rendered in the indicating two notches due to the multiplication in the Fourier domain of the reflectivity spectrum as shown in our FIG. 3e, and the source wavelet spectrum illustrated in U.S. Pat. No. 5,870,691 FIG. 3A. The notches in Partyka's thin bed reflection spectrum have a separation which is equal to

Δt=1/temporal thickness.

Partyka has expressed his invention as cited from col. 7, line 2: “In more particular, the invention disclosed herein is motivated by the observation that the reflection from a thin bed has a characteristic expression in the frequency domain that is indicative of the thickness of the bed: a homogenous thin bed introduces a periodic sequence of notches into the amplitude spectrum of the composite reflection, said notches being spaced a distance apart that is inversely proportional to the temporal thickness of the thin bed. Further, if the Fourier transform coefficients are properly displayed this characteristic expression may be exploited by the interpreter to track thin bed reflections through a 3-D volume and estimate their thicknesses and extent to a degree not heretofore possible.”

Partyka claims the following in the first claim of U.S. Pat. No. 5,870,691, as cited:
“A method for the exploration of hydrocarbons, comprising the steps of:
   (a) accessing a set of spatially related seismic traces, said spatially related seismic traces containing digital samples being characterized by at least a time, a position and an amplitude;
   (b) selecting a part of said set of spatially related seismic traces to define a zone of interest;
   (c) transforming at least a portion of said seismic traces within said zone of interest using a Fourier transformation, said Fourier transformation
(i) being characterized by a plurality of orthonormal basis functions, and
(ii) being applied to a window containing said digital samples to produce a plurality of transform coefficients associated with said orthonormal basis functions;
   (d) organizing said transform coefficients into a tuning cube;
   (e) multiplying said transform coefficients by a scaling value to form a scaled tuning cube, said scaling value being determined by
(i) selecting at least two transform coefficients corresponding to a same said basis function,
(ii) calculating a complex magnitude of all transform coefficients so selected,
(iii) calculating an average value from all transform coefficient magnitudes so calculated, and
(iv) calculating a scaling value from said average value;
and,
   (f) displaying said scaled tuning cube.”

A disadvantage of Partyka's approach occurs when the layer becomes very thin so as the first of the notches appear far to the right, i.e. for high frequencies in the frequency plot, as illustrated in FIG. 3h. The second notch will be even further out in frequency, and it may prove impossible to detect within the frequency spectrum of the source wavelet spectrum. Then the temporal thickness of a thin bed may be not be deduced by estimating the separation of two notches, as there is only one. For even thinner beds, the first notch may not even fall entirely within the source wavelet frequency spectrum. Thus the method of U.S. Pat. No. 5,870,691 is qualitative and not very robust.

### BRIEF SUMMARY OF THE INVENTION

The above mentioned problems related to finding the thickness of a thin layer is solved in a quantitative way by the present invention.

According to an aspect of the present invention, there is provided a method of estimating thickness of a geological layer (L), the method comprising the steps of:

(a) selecting seismic reflection field data from a subsurface depth interval of interest;
(b) providing a plurality of geological models having different layer thicknesses and providing respective model responses from the plurality of geological models;
(c) comparing a frequency spectrum of the seismic reflection field data with each of the frequency spectra of the model responses to derive comparison data associated with the different layer thicknesses of the models; and
(d) deriving from the comparison data a model layer thickness that is indicative of the thickness of the geological layer.

According to another aspect of the present invention, there is provided a method for quantitatively estimating a thickness of a buried geological layer (L), comprising the following steps:
using a seismic source (3) having a source wavelet spectrum (3f),
registering a seismic trace of reflection time domain data (5t), and
selecting a temporal interval (t₁, t₂) of said trace of seismic reflection data (5t) producing a time interval series of seismic reflection data (5ts) for which a thickness (Δt or d) of said layer (L) in said temporal interval is to be determined,
transforming said time interval reflection data (5ts) into a seismic interval frequency spectrum (5f).
   The novel features of the invention comprises:
repeating the following steps for a number of temporal thicknesses (Δt):
   generating an acoustic impedance model with a layer (Lₘ) having an impedance contrast (Δz) and said temporal thickness (Δt), and forming a model reflectivity function (Lₘₜ) in time,
   transforming said model reflectivity function (Lₘₜ) into the frequency domain producing a model reflectivity spectrum (L_{mf}),
[or forming such a model reflectivity spectrum directly]
   multiplying said model reflectivity spectrum (L_{mf}) with said source wavelet spectrum (3f), producing a thin layer model spectrum (Lₘₛ)
   correlating said thin layer model spectrum (Lₘₛ) with said seismic interval frequency spectrum (5f) producing a (single) correlation value (C(Δt)) as function of the instant temporal thickness (Δt),
selecting a peak value (C_{high}) in the so produced series of correlation values (C(Δt)) as function of the instant temporal thickness (C(Δt)), and letting the temporal thickness (Δt) corresponding to said peak value (C_{high}) indicate a thickness estimate (Lₘ) of said buried geological layer (L).

The steps of generating an acoustic impedance model with a layer (Lₘ) having an impedance contrast (Δz) and said temporal thickness (Δt), and forming a model reflectivity function (Lₘₜ) in time, and transforming said model reflectivity function (Lₘₜ) into the frequency domain producing a model reflectivity spectrum (L_{mf}), may alternatively be conducted by forming such a model reflectivity spectrum (Lₘₜ) directly, only knowing that it corresponds to the model reflectivity function in time.

In an embodiment, the method comprises that the reflectivity spectrum (Lₘₜ) is a zero offset reflectivity spectrum representing a current temporal thickness (Δt) of a zero offset reflectivity function (Lₘₜ).

In an embodiment, the method comprises that the seismic trace of reflection time domain data (5t) are so-called near-offset stack of near offset seismic traces.

In an embodiment, the method comprises that the seismic trace of reflection time domain data (5t) is a so-called intermediate-offset stack of intermediate offset seismic traces.

In an embodiment, the method comprises that the seismic trace of reflection time domain data (5t) is a so-called far-offset stack of far offset seismic traces.

In an embodiment, in the method according to the invention, before the step of forming a model reflectivity spectrum (L_{mf}) representing a current temporal thickness (Δt) of a reflectivity function (Lₘₜ), comprises
generating an acoustic impedance model with a layer (Lₘ) having an impedance contrast (Δz) and said temporal thickness (Δt), and forming said model reflectivity function (Lₘₜ) in time, and
transforming said model reflectivity function (Lₘₜ) into the frequency domain producing a model reflectivity spectrum (L_{mf}).

in an embodiment of the method it comprises selecting a maximum value (Cₘₐₓ) among said peak values (C_{high}) of correlation values (C(Δt)) as function of the instant temporal thickness (C(5t)), and letting the temporal thickness (Δt) corresponding to said peak value (Cₘₐₓ) indicate said thickness estimate (Lₘ) of said buried geological layer (L).

In an embodiment the method further comprises conducting the process for a number of seismic reflection traces (5t) registered in different geographical locations, to produce a thickness estimate (Lₘ) of said buried geological layer (L) for part or all of said geographical locations.

In an embodiment the method further comprises that the number of seismic reflection traces are registered in a number of different geographical locations covering a seismic profile line section of the Earth.

In an embodiment the method further comprises that the number of seismic reflection traces are registered in a number of different geographical locations covering a volume of the Earth.

In an embodiment of the invention comprises selecting the temporal interval (t₁, t₂) of the trace of seismic reflection data (5t) producing a time interval series of seismic reflection data (5ts) for which a thickness (d) of a layer (L) in the temporal interval is to be determined, based on manually determining the temporal interval (t₁, t₂) from apparent reflections in the trace of seismic reflection data (5t).

In an embodiment of the invention it comprises selecting the temporal interval (t₁, t₂) of the trace of seismic reflection data (5t) producing a time interval series of seismic reflection data (5ts) for which a thickness (d) of a layer (L) in the temporal interval is to be determined, based on interpolating or extrapolating corresponding a temporal interval (t₁ₙ, t₂ₙ) comprising relevant reflections in one or more neighbour traces of seismic reflection data (5tₙ).

In an embodiment of the invention it comprises producing the frequency domain source wavelet (3f) by measuring a source signature wavelet (3t) in the time domain, and transforming the source time domain wavelet (3t) into the frequency domain source wavelet (3f) by a Fourier transform.

In an embodiment of the invention it comprises producing the frequency domain source wavelet (3f) by transforming one or more extensive seismic reflection traces into the into the frequency domain, thereby producing a source wavelet (3f).

In an embodiment of the invention the seismic trace of reflection time domain data (5t) is a trace registered on one single seismic sensor.

In an embodiment of the invention the seismic trace of reflection time domain data (5t) comprises traces registered on a multiplicity of seismic sensors and stacked to form the seismic trace of reflection time domain data (5t).

In an embodiment the temporal interval (t₁, t₂) is varied over a geographical area in order to pick up a thin layer of which the depth to top and bottom varies over the geographical area.

In an embodiment of the invention, in the step of generating an acoustic impedance model with a layer (Lₘ) having an impedance contrast (Δz) and the temporal thickness (Δt), and forming a model reflectivity function (Lₘₜ) in time, introducing within the temporal interval (t₁, t₂) other empirical impedance contrasts and temporal thicknesses for layers ahead of or after said layer (Lₘ).

An embodiment of the present invention will be explained below under the paragraph named “Description of an embodiment of the invention”.

### BRIEF DESCRIPTION OF THE DRAWINGS

The invention is illustrated in the attached drawings which are meant to illustrate the invention without limiting the scope of the invention. In the drawings:

FIG. 1 is an illustration of an observed reflection signal as function of a true or model layer thickness shown in FIG. 1b. An interpreted wedge model is also illustrated in FIG. 1a, in which the interpreted model becomes too thick for thin layers. The wedge model is centred at 200 ms two-way reflection time.

FIG. 1a shows tuning effect on interpretation of thickness. FIG. 1b shows top and base reflector interfaces (continuous line) forming a geological model, and interpreted thickness from the reflection signals from the top and the base, in the same vertical scale and two-way time thickness as indicated in FIG. 1a.

FIG. 2 presents graphs of interpreted layer thickness as a function of the model layer thickness, for the model illustrated in FIG. 1b. As above, the interpreted thickness does not extend below 11 ms despite the model behind approaching zero thickness.

FIG. 3a illustrates acoustic impedance of a very simple geological model, an acoustic impedance of a geological model with one anomalous layer forming a contrast to the homogenous overburden and underlying rocks. i.e. the model is a sill in geological terms. z₁=5*10⁶ (m/s)*(kg/m3), z₂=4*10⁶ (m/s)*(kg/m3) FIG. 3b is a display of a zero offset reflectivity according to the model of FIG. 3a, the reflection coefficients thus being:

r₁=(z₂−z₁)/(z₂+z₁)=−0.11

r₂=(z₃−z₂)/(z₃+z₂)=+0.11.

FIG. 3b, which is a |sin| curve which is zero for 0 Hz, and the broken curve represents the corresponding transform for reflectors of equal sign, which is a similar |cos|-curve with notches but displaced by half the notch separation relative to the |sin|-curve.

FIG. 3c illustrates the data from the zero offset reflectivity of FIG. 3b convolved with a 30 hz Ricker pulse. Note that this is in the time domain, and that the interference of the side lobes of the Ricker pulses is not very visible.

FIG. 3d shows the 30 Hz Ricker wavelet in the frequency domain and in time domain, the Fourier transform of the 30 Hz Ricker pulse of FIG. 3c. The frequency spectrum is symmetrical about 0 Hz.

FIG. 3e displays the zero offset reflectivity in the frequency domain, graphs of the Fourier transform of the zero offset reflectivity for opposite acoustic impedance reflectors according.

FIG. 3f is the frequency spectrum of the zero offset reflectivity spectrum of FIG. 3d multiplied with the Ricker pulse's wavelet spectrum. This figure thus represents an idealized model of the spectrum of a noise-free reflection of one single reflecting geological formation.

FIG. 3g illustrates background art illustrating a source wavelet spectrum at the left side of the sheet, and, at the right side of the sheet, the spectrum of a reflection of a geological bed of which the temporal separation between a top and a bottom of the geological bed is assessed based on the frequency separation between two notches in the reflection spectrum.

FIG. 3h illustrates a problem related to the above illustrated background art when the temporal thickness becomes very small, and the first notch is high in the source wavelet's spectrum and the second notch is above the spectrum, thus rendering thickness assessment difficult.

FIG. 4a is similar to FIG. 3a and is added a series of extra acoustic impedance variations to resemble a more realistic geological model, and retaining the low impedance zone at about 200 ms twt.

FIG. 4b is the zero offset reflectivity of FIG. 4a, illustrating the added noise. Note that the reflectivities r₁ at the top and r₂ at the bottom of the low impedance zone are not equal.

FIG. 4c corresponds to FIG. 3c and displays a curve of the slightly noisy zero offset reflectivity convolved with a 30 Hz Ricker pulse wavelet.

FIG. 4d corresponds to FIG. 3d and is the Fourier transform of the 30 Hz Ricker wavelet.

FIG. 4e corresponds to FIG. 3e and represents the Fourier transform of the zero offset reflectivity time domain series as illustrated in FIG. 4b.

FIG. 4f displays the somewhat noisy zero offset reflectivity spectrum of FIG. 4e multiplied by the Ricker wavelet spectrum of FIG. 4d and thus provides a more realistic image of zero offset data in the frequency domain. The frequency spectrum shown in FIG. 4f may thus represent the frequency spectrum of a relatively short time section of seismic data containing a relatively thin layer, the possible presence of the thin layer revealed by the notch at 40 hz.

FIG. 5a illustrates a feature of the invention in that a correlation may automatically be calculated between the frequency spectrum of a selected time section of seismic reflection data, and a set of frequency spectrum models along the abscissa, the frequency spectrum models representing a contained layer of increasing temporal thickness. The model layer temporal thickness varying from 4 ms (the usual sampling rate) to 85 ms.

The maximum correlation value corresponds to a temporal thickness of the contained layer in the model that best makes the measured data fit the model. The correlation process may thus be robust in that one does not need the entire spectrum including a first notch in order to find a correlation between the model and the measured data, as long as the data are above the noise level.

FIG. 5b displays the frequency spectrum of a short time series of noisy model data from above to below a layer (jagged line) and a corresponding frequency spectrum of a source spectrum multiplied with a model spectrum based on a given model layer thickness. A series of such two curves are correlated in FIG. 5a. FIG. 5b shows a correlation between data in the frequency domain given a wavelet and a proposed thin layer thickness of 0.232 ms (smoother line), and modeled noisy frequency domain data and a given thickness of a low impedance layer, such as from FIG. 4f. This correlation gives the maximum correlation for the thickness of the thin low-impedance bed such as given in FIG. 5a for a temporal thickness of 0.232 ms.

FIG. 6 shows a wedge model as seen in the Fourier domain, remaining notch traces of interference pattern due to source signature frequency spectrum. FIG. 6 displays a generally continuous series of frequency spectra of models with layer thicknesses increasing from zero at the left side, to 40 ms layer thickness at the right side, in which the frequency spectra are multiplied by a source signature frequency spectrum of a Ricker wavelet. Please notice the absence of notches above the upper frequencies of the Ricker wavelet's spectrum.

FIG. 7 displays frequency domain interference pattern for reflectors of opposite sign, a generally continuous series of frequency spectra of models with layer thicknesses as for FIG. 6. Here, the source signature has not been multiplied in, and thus the |sin(w)| shape of each profile prevails without limits of the amplitude spectrum of any Ricker wavelet.

FIG. 8a is an example of a map of interpreted thicknesses compared to a map of inverted thicknesses as made using background art time-domain picking, versus a map as in FIG. 8b made using the correlation method of the present invention for finding an estimate of layer thicknesses.

FIG. 8c is similar to FIG. 2 and displays the interpreted thicknesses displayed in the map of FIG. 8a plotted versus the inverted thicknesses calculated according to the method of the present invention.

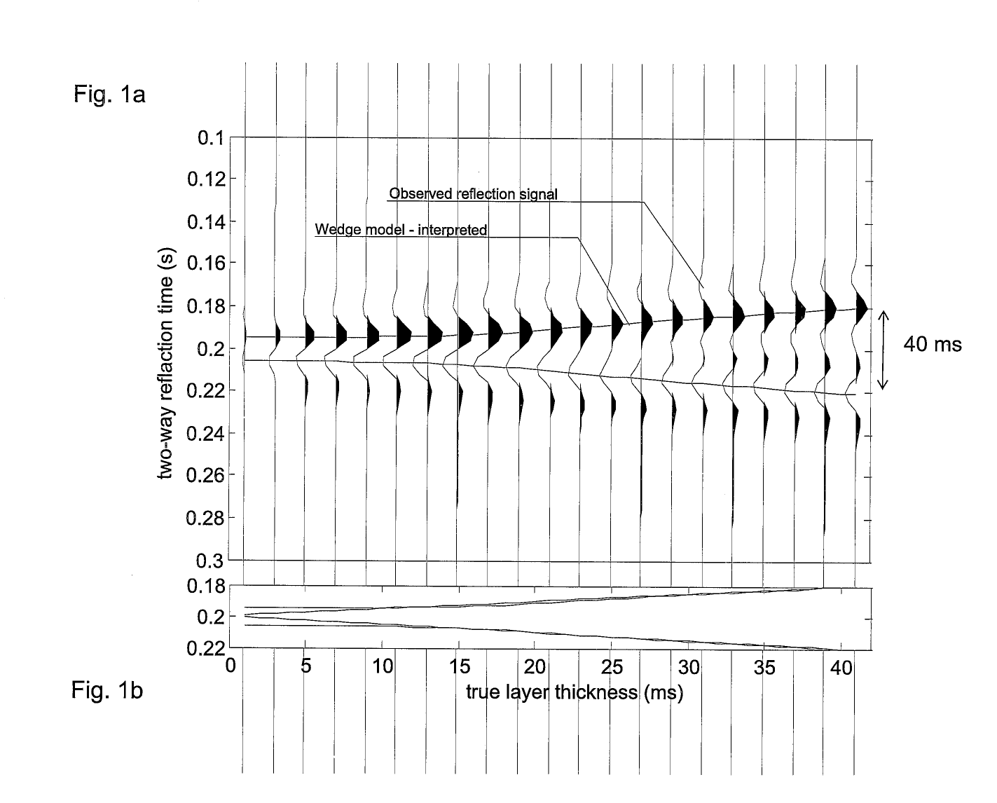

### DESCRIPTION OF AN EMBODIMENT OF THE INVENTION

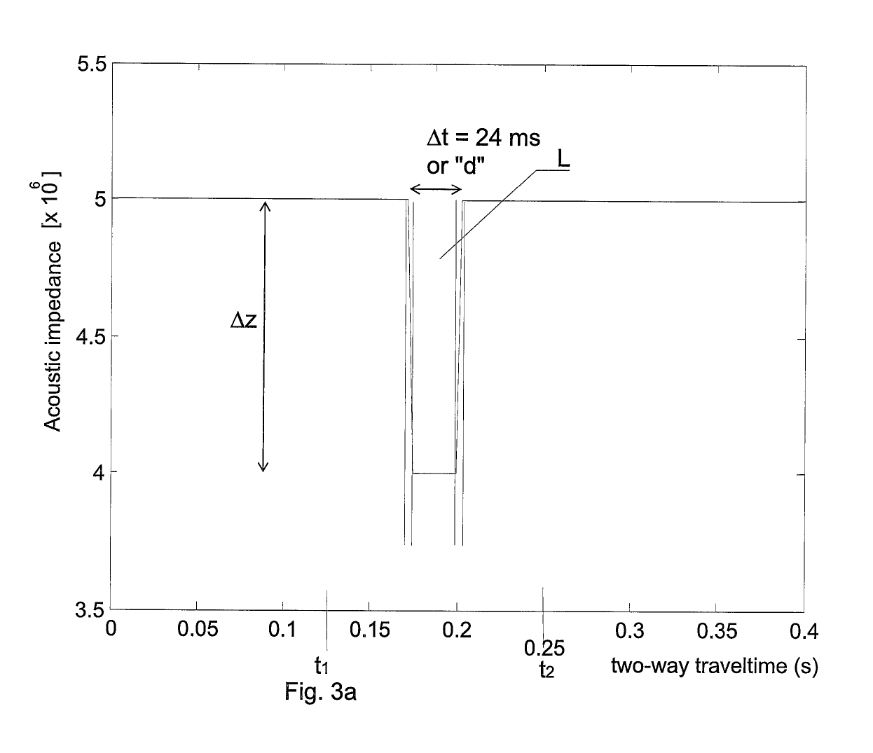

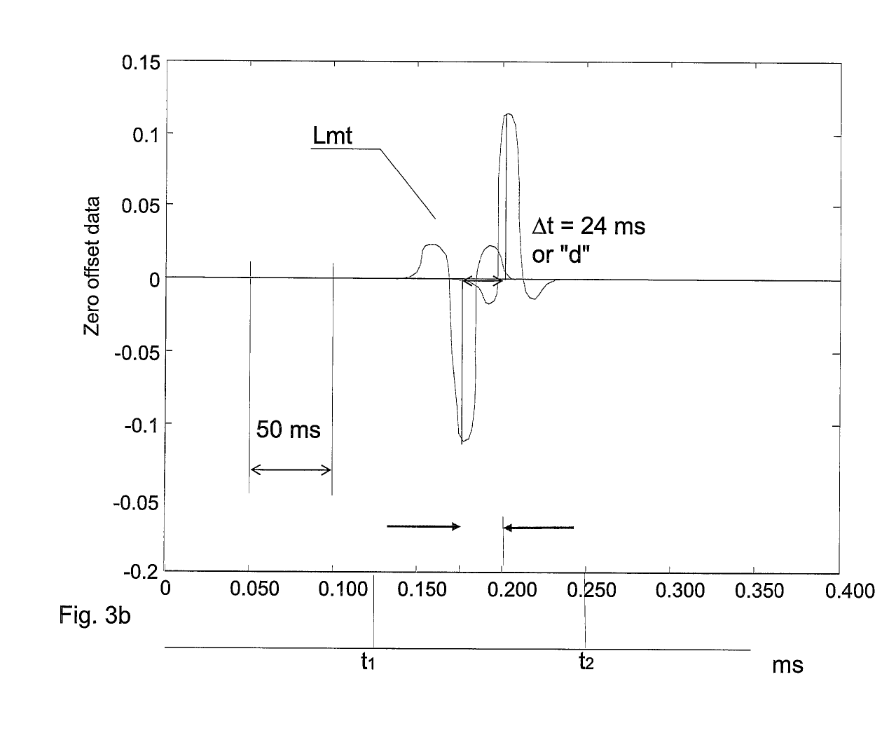

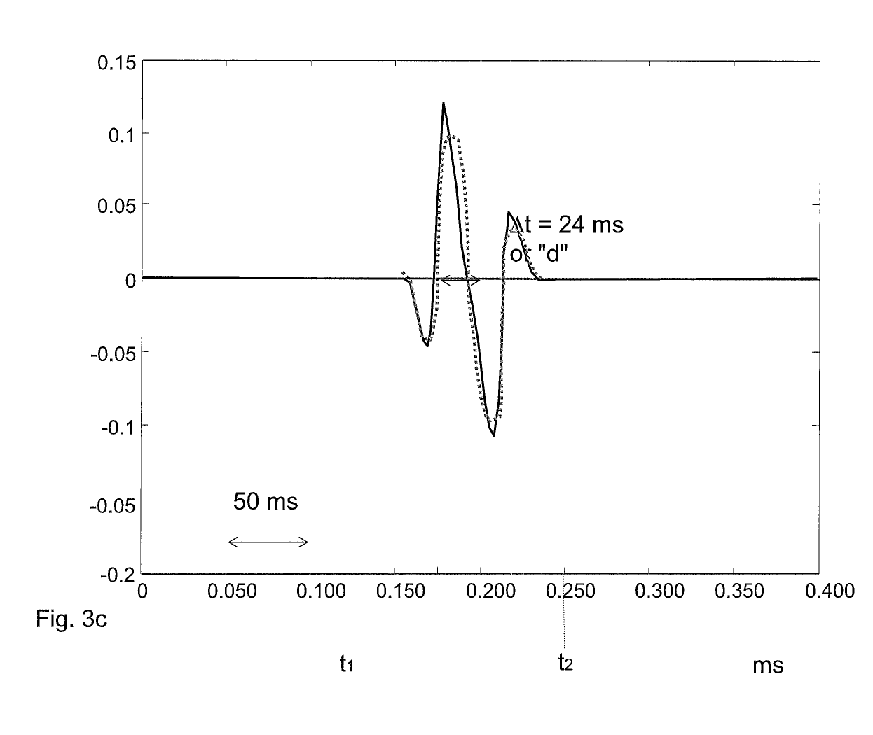

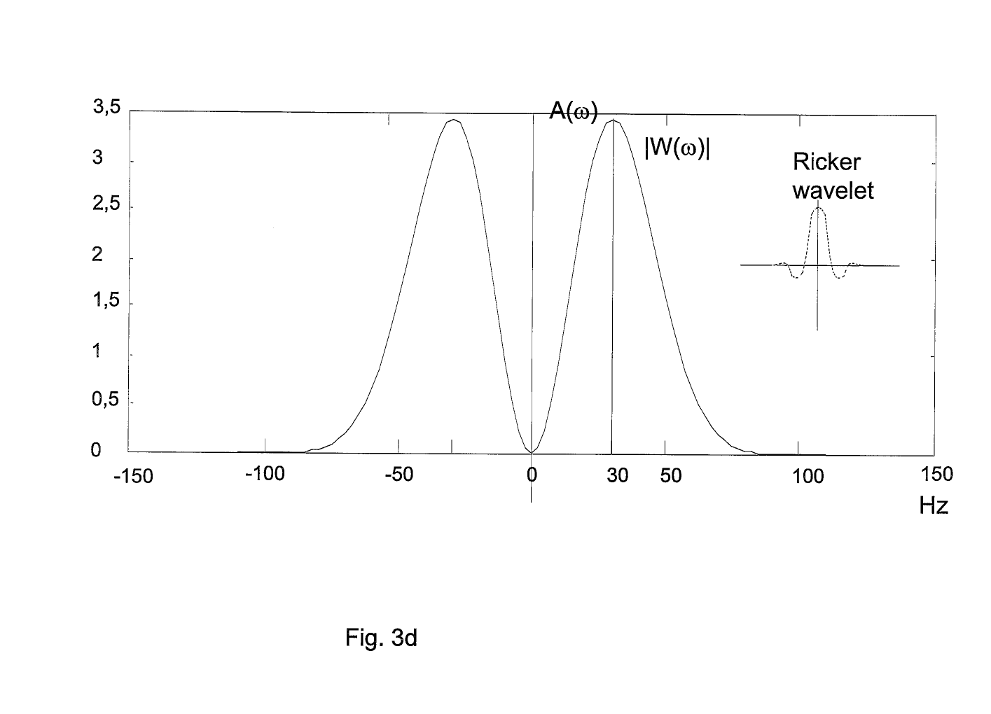

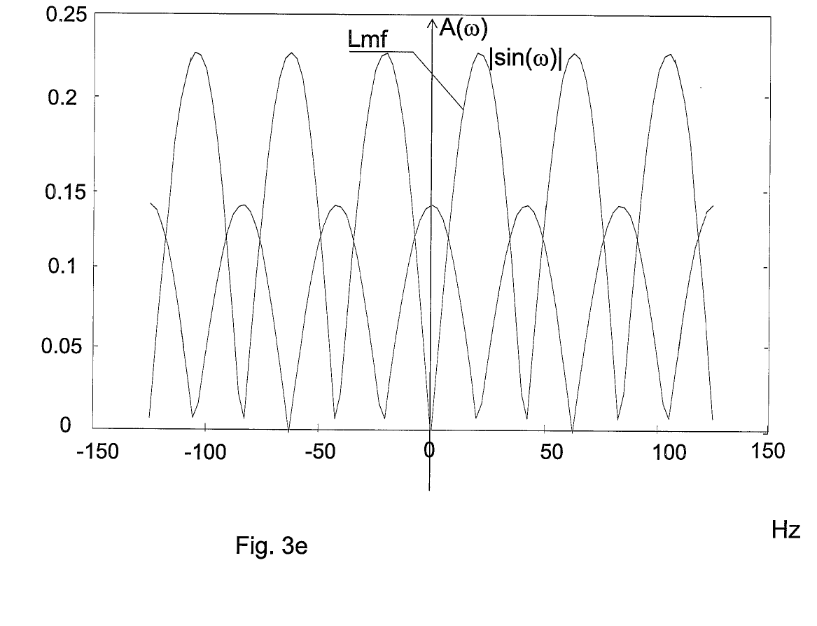

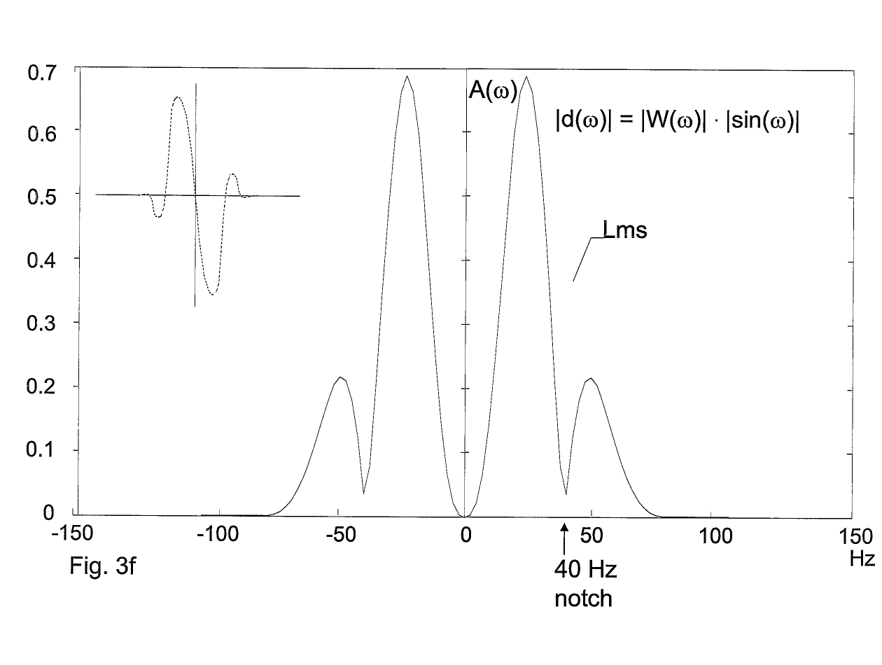

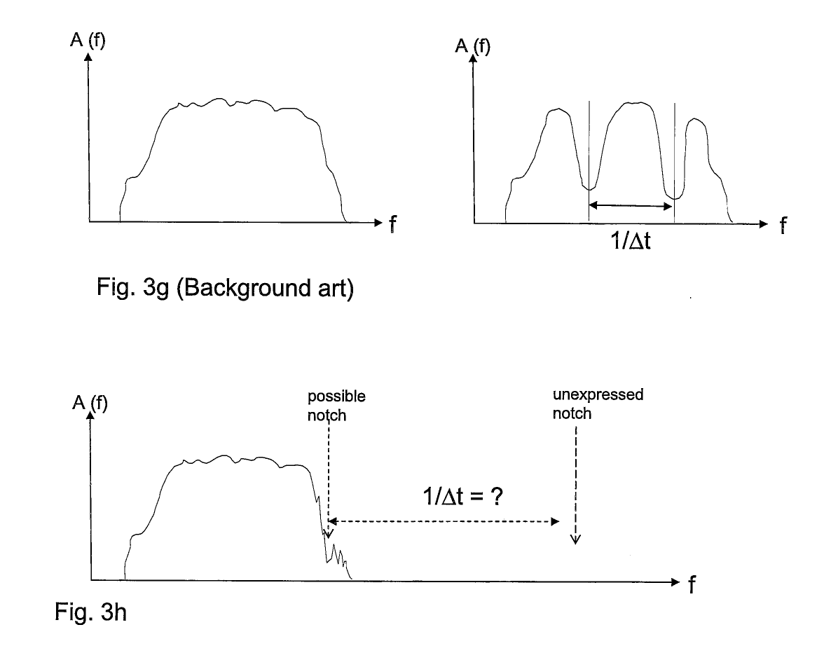

The interference pattern of two reflectors in the frequency domain is thus either
a |sin|-function as shown in FIG. 3e if the reflectors are of opposite sign, as in FIGS. 3a and 3b, or
a |cos|-function as shown by the broken line in FIG. 3e, if the reflectors are of the same sign.

The seismic signal of two reflectors in the frequency domain is, as explained above, the source signature multiplied by such a |sine| or a |cosine| depending on the two acoustic impedance contrasts represented by the thin layer in question. For the purpose of estimating thicknesses, the phase is not relevant, so it is only the power spectrum that matters. This gives two equations:

|dₒ(ω)|=|W(ω)|·|sin(ω)|, for reflectors of opposite sign, and

|dₛ(ω)|=|W(ω)|·|cos(ω)|, for reflectors of the same sign,

where W(ω) is the seismic source signature.

As is well known the source signature spectrum may be either measured directly or by averaging the seismic spectrum over a long time series of reflections. The thickness of the layer may thus be found as the frequency for which the correlation of the source signature and the |sin| or |cos| wave that maximises |d(ω)|.

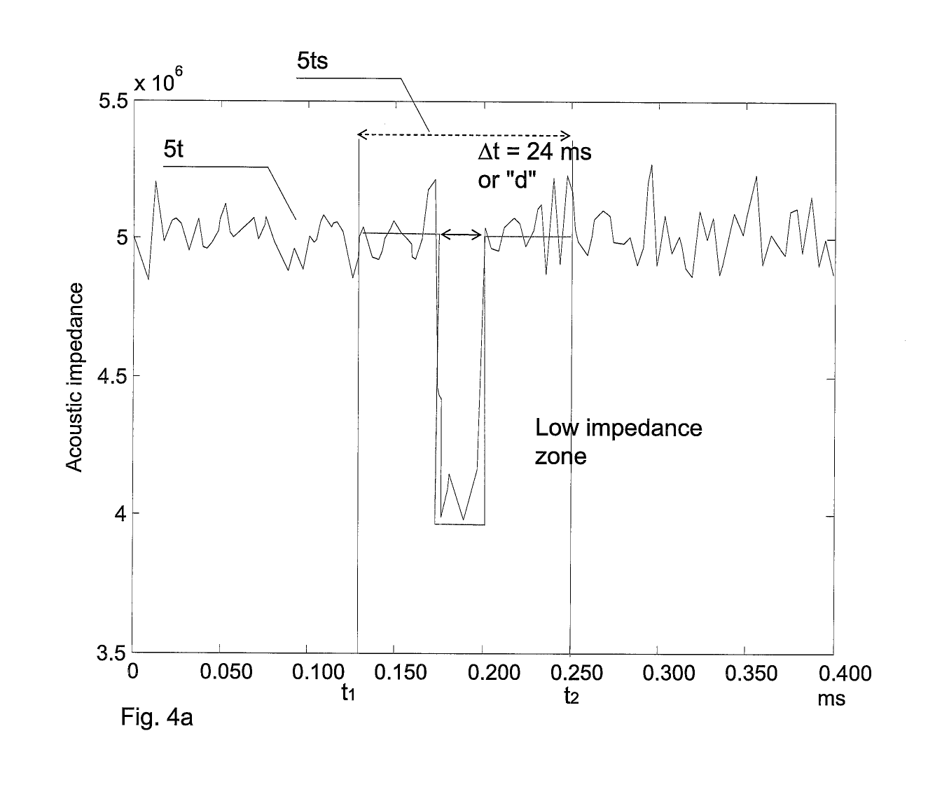

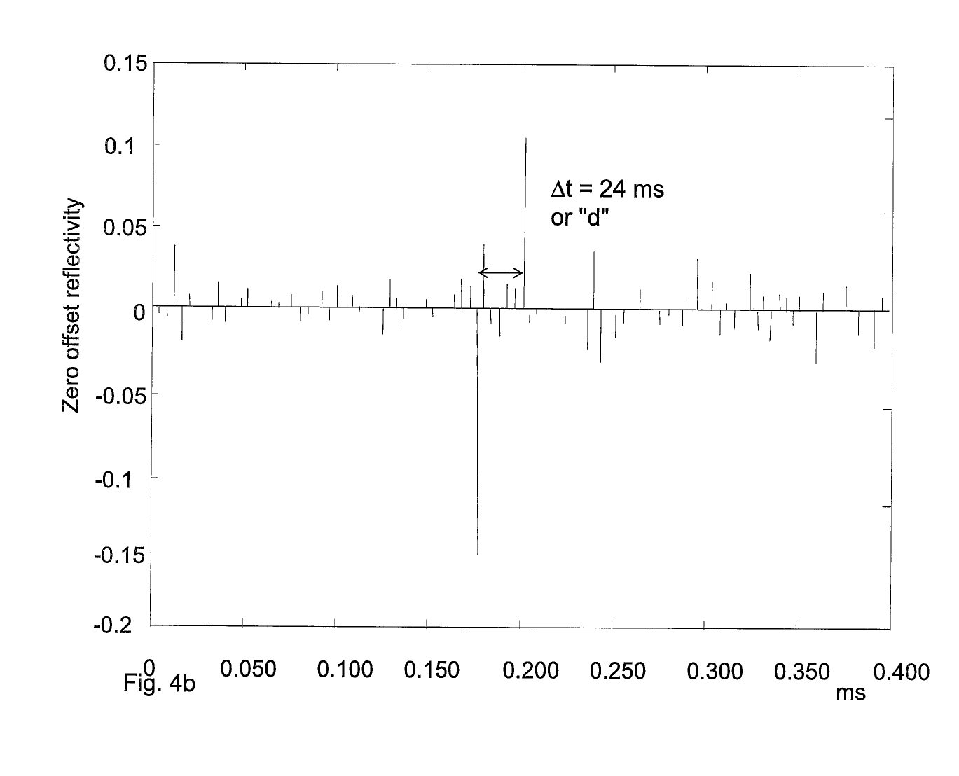

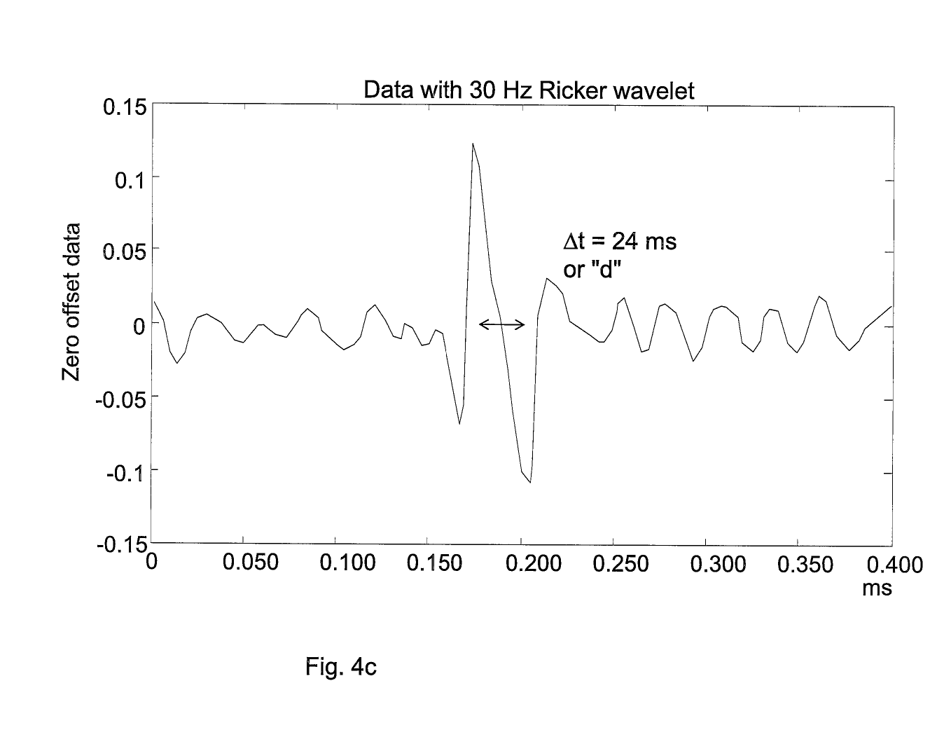

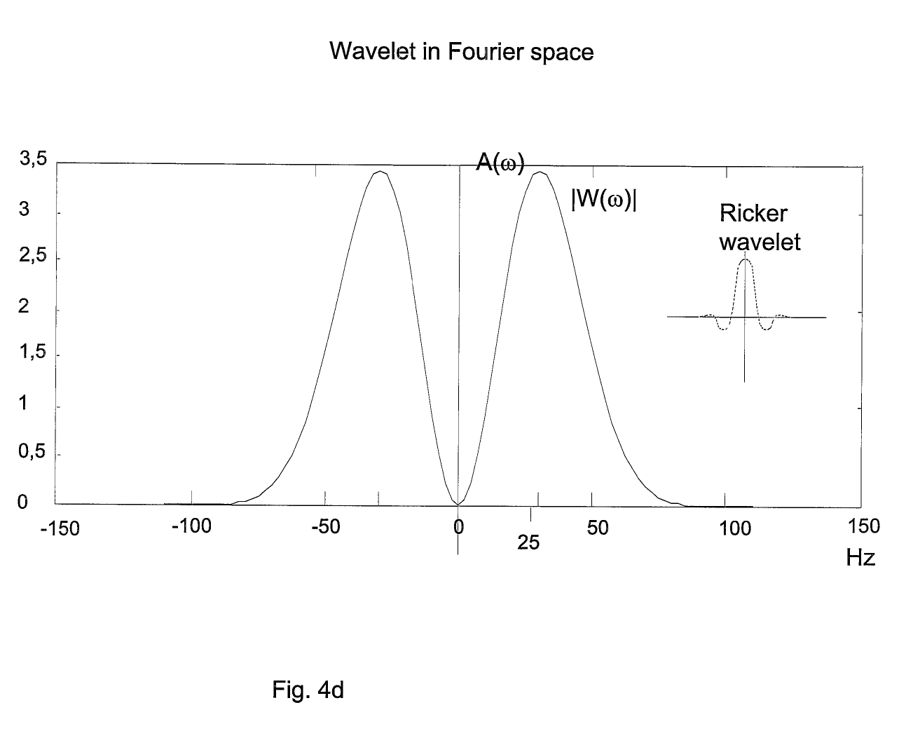

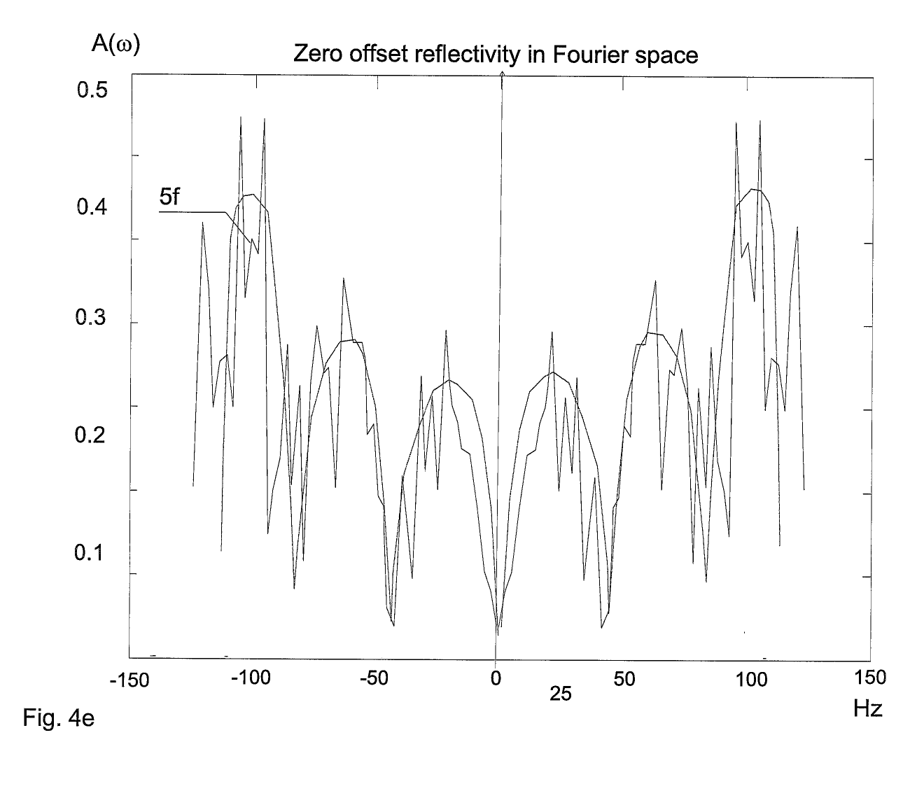

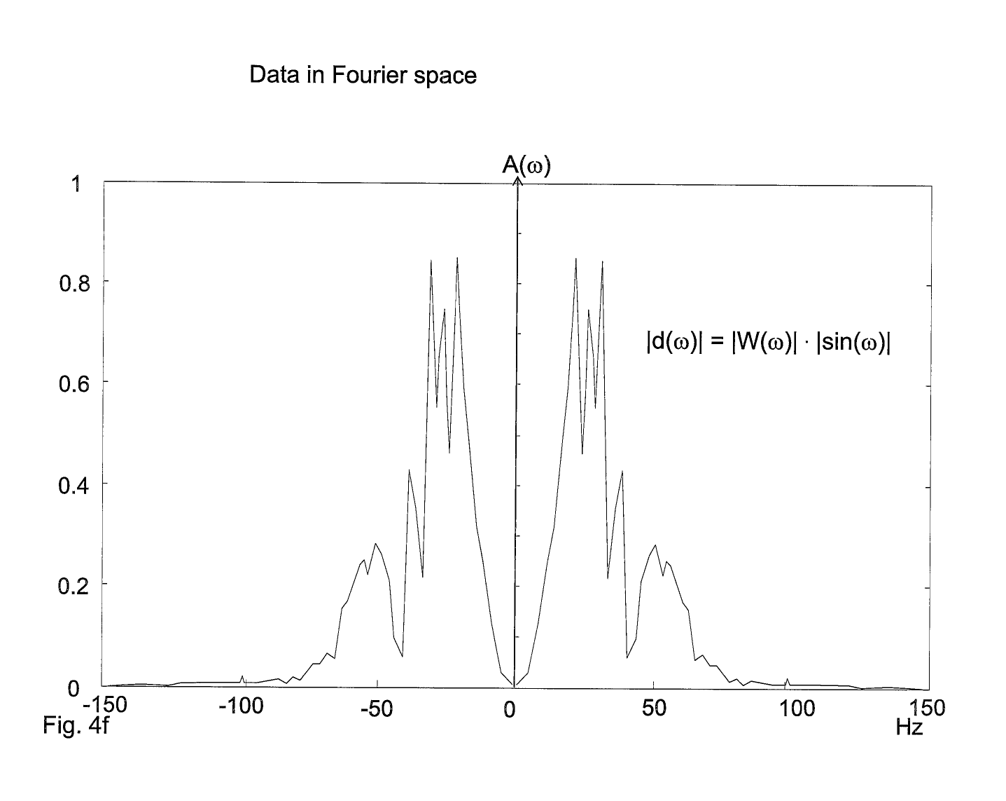

Instead of using the qualitative approach of Partyka et al, in the present invention a quantitative approach is made to find the temporal thicknesses of a thin layer. If we have a real wavelet spectrum, we may try to match the real data with different thicknesses. Adding some extra reflectors will provide a more realistic test. FIG. 4a illustrates a geology similar to that of the oversimplified model of FIG. 3a, but in addition to the low-impedance zone of 0.240 s between 0.176 ms and 0.200 ms, we have added randomly varying impedances about the mean acoustic impedance of 5·10⁶ kg/m²s, for each 4 ms digital sampling interval. Further, the same random variations have been added to the low impedance zone of 4·10⁶ kg/m²s. The zero offset reflectivity of the model given in FIG. 4a is shown in FIG. 4b, which shows, in addition to the reflectivities of the upper and lower boundary reflectivities of the low-impedance zones also displays the smaller random reflectivities. FIG. 4c displays the zero-offset reflectivities of the low-impedance zone with random noise according to FIG. 4b convolved with the 30 Hz Ricker wavelet in the same manner as for FIG. 3c.

We may continue by looking at the corresponding data in the frequency domain. The wavelet of the Ricker pulse such as illustrated in FIG. 3d is repeated in FIG. 4d. The zero-offset reflectivity shown 4 ms sample in FIG. 4b is Fourier transformed to the frequency domain and shown in FIG. 4e. We see the resemblance of the repeating “beat frequency” of 40 Hz, even though the reflectivity as expressed in the frequency domain is not as “sine”-like as for the noise-free model of FIG. 3a, the resulting zero-offset frequency domain data have kept their shape.

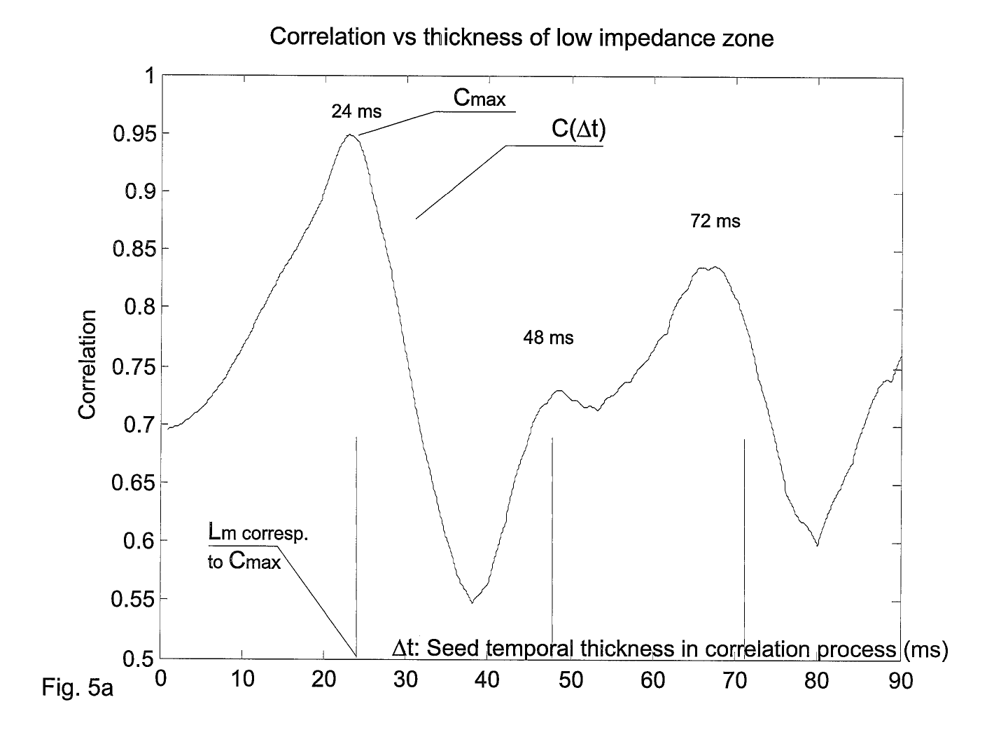

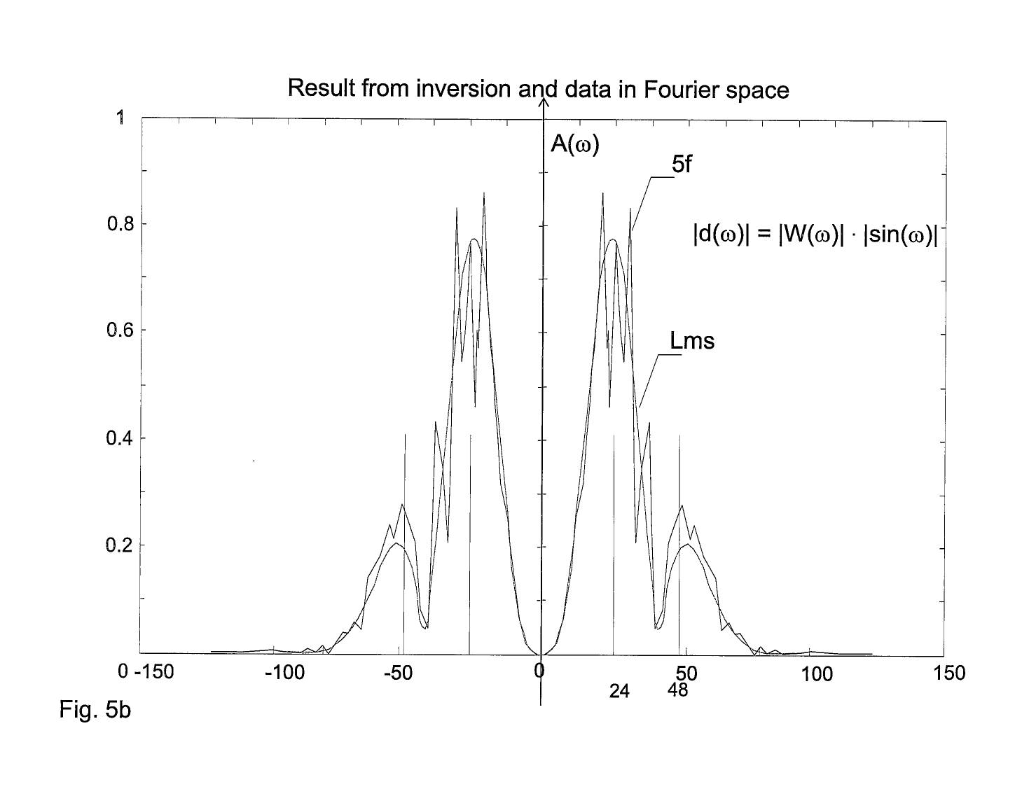

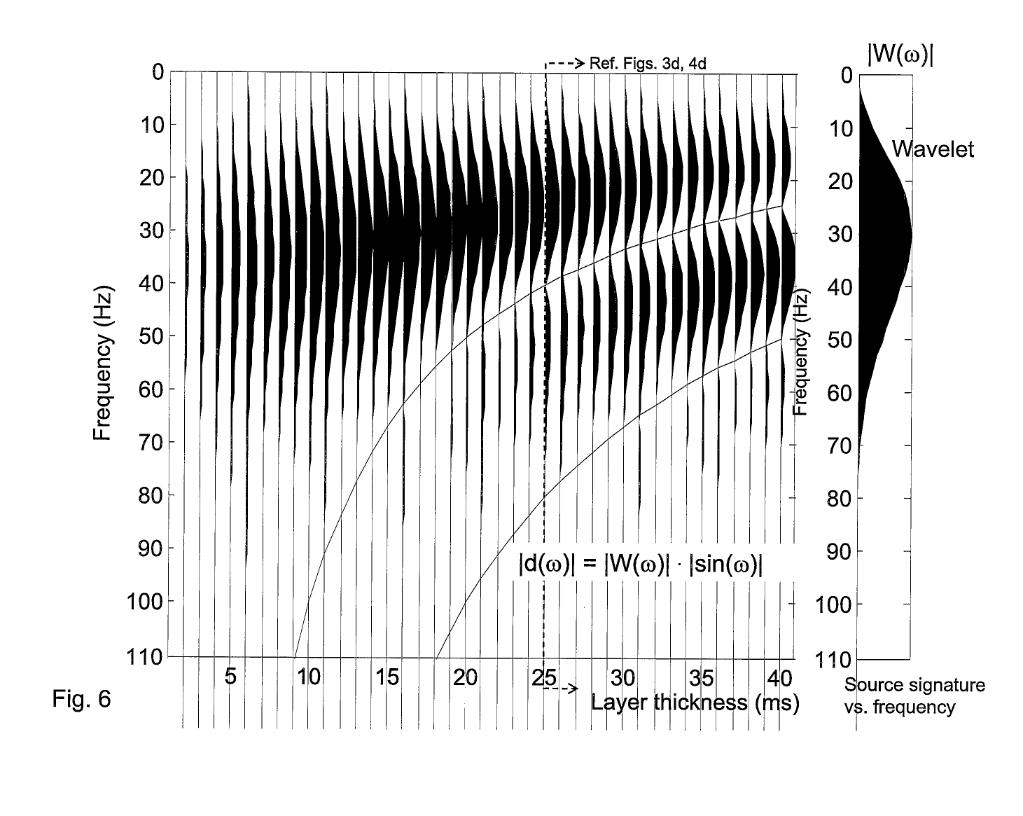

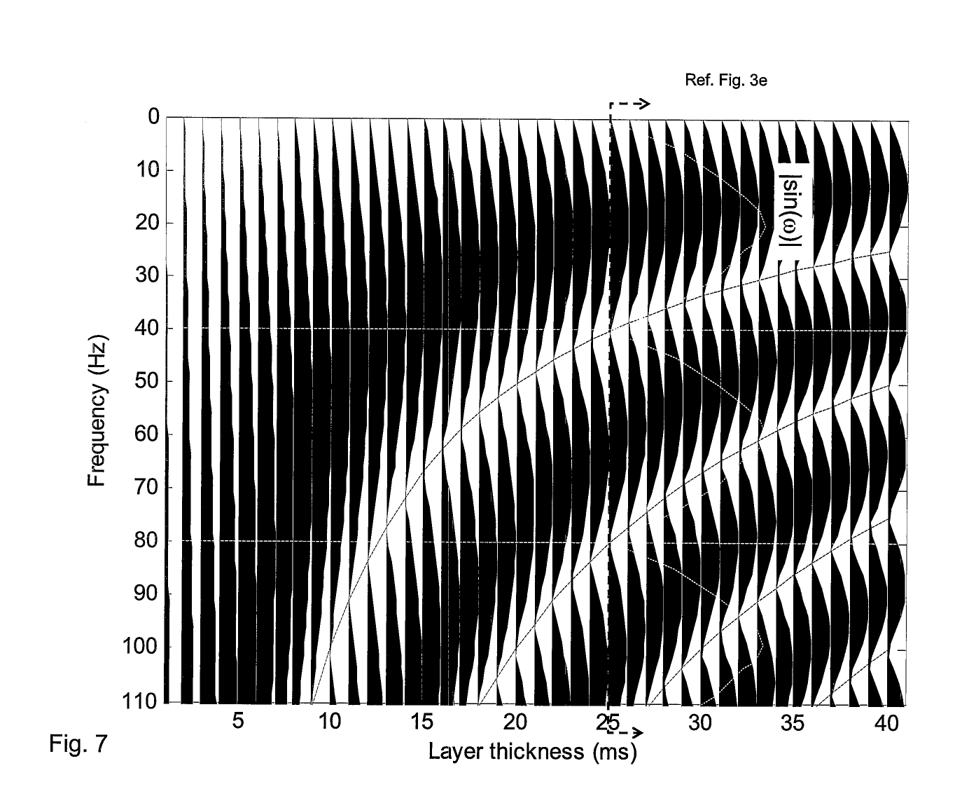

The method described models data in the frequency domain given a wavelet and a proposed thin layer thickness such as shown in FIG. 3f. The modelled data are then correlated to the frequency domain transform of the real data and thickness such as in FIG. 4f, and a maximum correlation as a function of model thickness is picked. FIG. 5a shows such correlations given as a function of the proposed thicknesses given in milliseconds. FIG. 5b is an illustration of a comparison between data in the frequency domain given a wavelet and a proposed thin layer thickness of 0.0232 ms (smoother line), and the modeled noisy frequency domain data and a given thickness of a low impedance layer, such as from FIG. 4f. This correlation gives the maximum correlation for the thickness of the thin low-impedance bed such as given in FIG. 5a for a temporal thickness of 0.0232 ms. This analytically found maximum correlation for one single trace compares well with the correct model value of 0.024 ms. The error is 0.008 ms, which is ⅕ of the sample rate of 4 ms. It is seen that there are lower maxima in FIG. 5a near 48 ms and 72 ms also, which are multiples of the 24 ms thickness. This exemplifies a robustness of the present method that is independent of picking a notch in the frequency spectrum: The present invention calculates the correlation between the entire curve of (Lₘₛ) the frequency spectrum of the source wavelet comprising the notch according to the modeled thickness, and the actual suspected thin-bed-notch-containing frequency spectrum (5f) of the time interval (depth interval) under consideration, such as illustrated in FIG. 5b.

For some seismic surveys a geological feature of interest may only show up in some seismic traces for a given offset range such as near or intermediate offset. The method according to the invention may be used with so-called stacked seismic data from near-offset traces, with so-called intermediate-offset stacked seismic data from intermediate-offset traces, from so-called far-offset stacks of far-offset traces, in order to pick up such geological features of interest. Of course, one may also utilize so-called full stack data from all available near to far seismic traces with the present method. However, one should be aware of the problem of the attenuation of high frequencies of the seismic signal and the fact that the seeming “source signature” has a reduced amplitude in the high frequency portion for far offset data. One should also be aware of the fact that the seismic source spectrum should have a width in order for the method to work, i.e. the source should not be a single frequency sine wave generator. The method according to the invention should have no limitation with respect to wave modes, either P or S waves; both should work well.

### ADVANTAGES OF THE INVENTION

The invention has the following advantages:

The method according to the invention may be conducted by repeating the following steps for a number of temporal thicknesses (Δt), thereby making the method more or less automatic. An acoustic impedance model is generated, the model having a layer (Lₘ) with an impedance contrast (Δz) and the above stepwise generated temporal thickness (Δt). Thus a model reflectivity function (Lₘₜ) as a function of time is formed.

The model reflectivity function (Lₘₜ) is transformed into the frequency domain producing a model reflectivity spectrum (L_{mf}).

The model reflectivity spectrum (L_{mf}) is multiplied with said source wavelet spectrum (3f), resulting in a reflectivity model spectrum (Lₘₛ).

Advantageously, instead of picking differences between notches in the seismic interval frequency spectrum as done by Partyka et al, the entire spectrum of the seismic interval frequency spectrum (5f) is used in the step of correlating the reflectivity model spectrum (Lₘₛ) with the seismic interval frequency spectrum (5f) producing one single correlation value (C(Δt)) as function of the instant temporal thickness (Δt). This process is repeated for all temporal thicknesses relevant, e.g. made in an algorithm loop starting with a large temporal thickness such as 85 ms and decreasing incrementally for each loop until a lowest temporal thickness such as 4 ms is reached, i.e. going from right to left along the temporal thickness axis in the diagram of FIG. 5a.

Automatically selecting a peak value (C_{high}), preferably a maximum value, in the so produced series of correlation values (C(Δt)) as function of the instant temporal thicknesses (Δt)), and letting the temporal thickness (Δt) corresponding to said peak value (C_{high}) or maximum value indicate a thickness estimate (Lₘ) of said buried geological layer (L), may provide an efficient method to delineate more accurately a thin layer and provide a more realistic estimate of the layer thicknesses' geographical distribution.

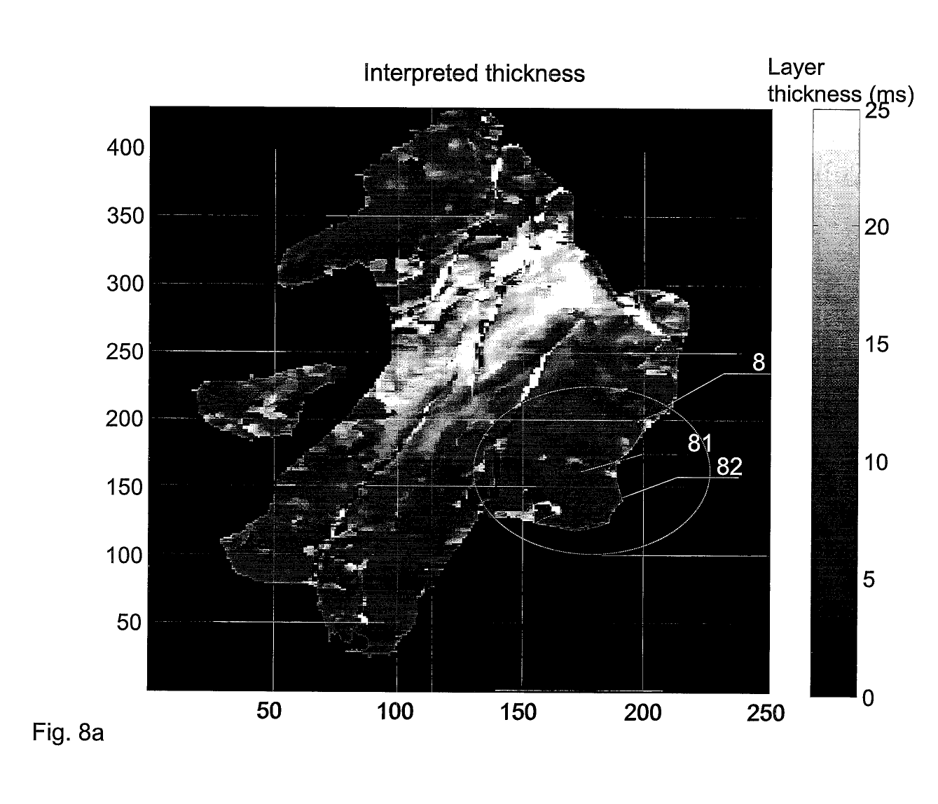

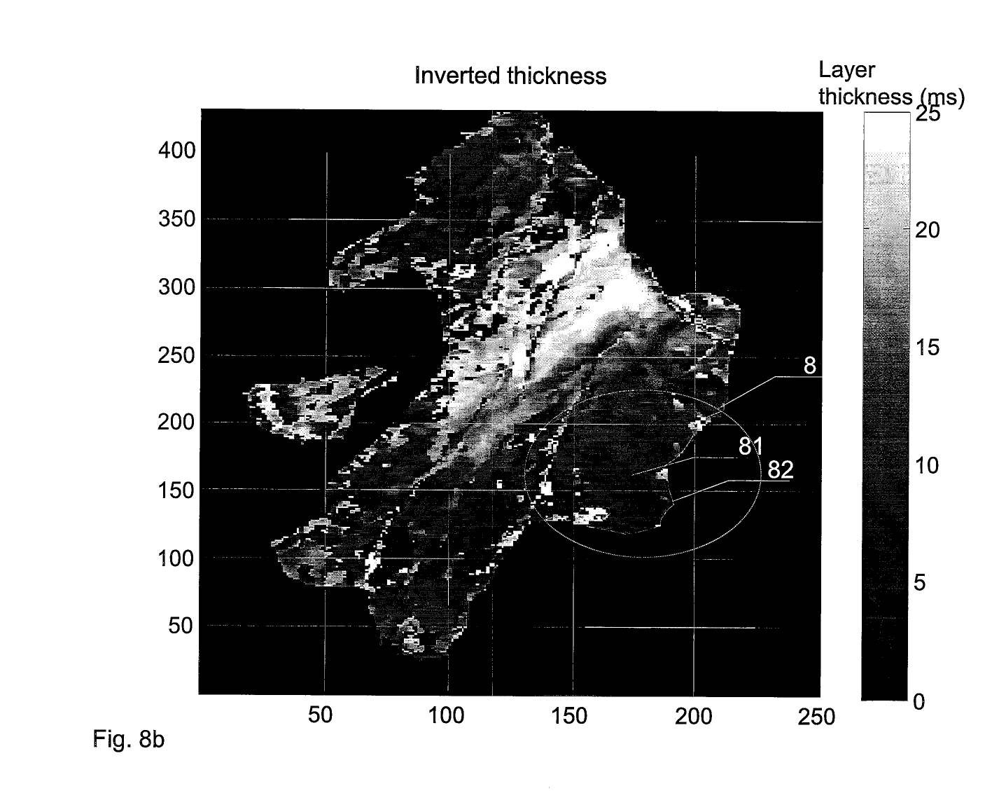

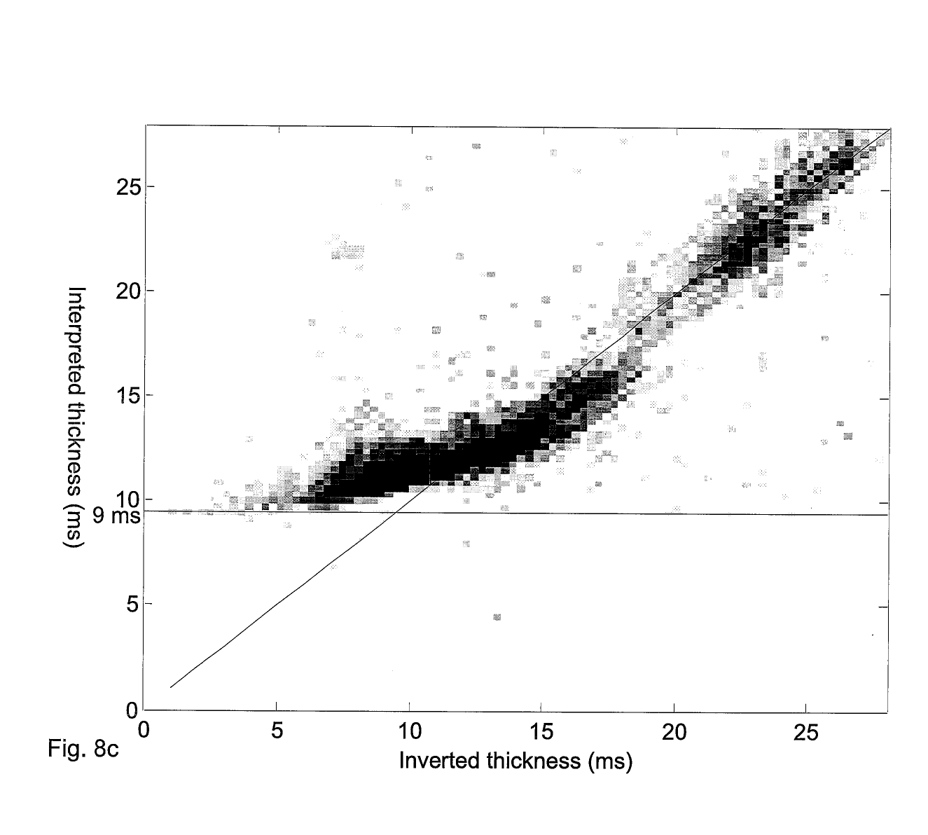

An example of the quantitative results of the method is given in FIG. 8b as compared to the results of conventional interpretation of top- and bottom picking of the seismic thickness (i.e. temporal, in ms) of a selected layer as shown in FIG. 8a. The mapped area displayed in FIG. 8a and FIG. 8b extends from 945 km to 990 km, i.e. 45 km in the N-S direction, and from 1150 km to 1175 km, i.e. 25 km in the W-E direction.

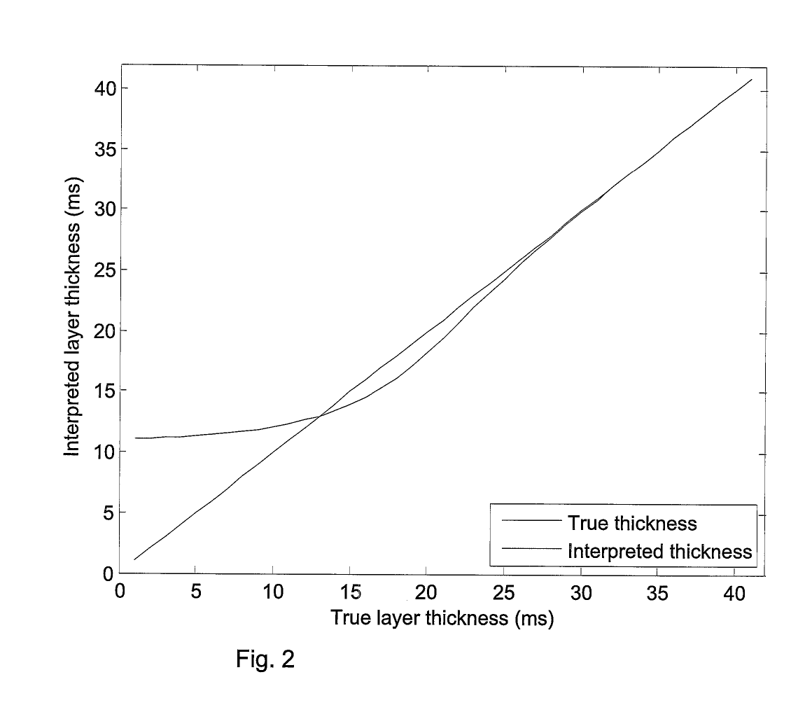

In FIG. 8a, the interpreted thicknesses of the layer in question varies from more than 25 m and down to about 9 or 10 ms at the minimum. No areas with a seismic layer thickness (in time) less than about 10 ms are indicated, as expected from the lower limit shown in FIG. 2 displaying interpreted layer thickness vs. “true” (model) layer thickness. Outside the clearly indicated lower interpreted thickness there is not indicated any seismic thickness at all, which would be an unlikely geological situation.

In FIG. 8c is illustrated a plot of the interpreted thicknesses as a function of the inverted thicknesses calculated according to the invention. Clearly, a lower limit of a major proportion of interpreted thicknesses is about 9 ms, whereas a major proportion of the inverted thicknesses according to the invention goes all the way down almost to zero. This example corresponds very well with the graph of FIG. 2.

In FIG. 8b, the inverted thicknesses of the layer in question varies rather as the interpreted thicknesses when the layer thickness is more than about 10 ms. A more or less circular area is indicated by a black broken line (8) having the same position in both maps of FIG. 8a and FIG. 8b. While all interpreted thicknesses in the indicated area (8) in FIG. 8a generally is more than 10 ms in thickness, there is a sub-area (81) in FIG. 8b, within the indicated area which is bounded by a broken boundary line (82), said sub-area (81) having coherent portions clearly indicating a calculated temporal thickness according to the invention of significantly less than 10 ms. Clearly, the interpreted thickness in large parts of the sub-area (81) is thicker than the inverted thickness according to the invention. It is an advantage of the present invention to yield a more correct, less thickness than the interpreted thickness. Reducing the thickness estimate may provide more realistic volume estimates of a layer.

Further to this, the broken boundary line (82) delimiting the coherent sub-area (81) indicated in FIG. 8b, has been copied to the same position in FIG. 8a. Clearly, the coherent thin layer distribution boundary line (82) forming the limit for beyond there is more or less noise (or instability) in the inverted data (the noise or instability indicated by a distribution of all colours) extends outside a corresponding interpreted sub-area (83) of FIG. 8a. This provides an indication that the method according to the invention provides stable temporal thickness estimates below the lower limits of time domain interpretation of the thickness of a thin geological layer.

### SUMMARY

All in all, the method according to the invention provides an automated method for estimating the thicknesses of a thin layer in seismic data. The layer may be a geological layer having an upper and a lower acoustic impedance contrast. The layer may also be a fluid layer within a geological layer, in which an interface of the fluid provides an acoustic impedance contrast, e.g. due to a water/oil interface, a water/gas interface or an oil/gas interface. Thus the method according to the invention may be used in 4-D seismics during the production of a field to monitor the elevation or thickness of a fluid layer. Further, the method according to the invention may be used for providing a more accurately inverted thickness distribution of a thin layer over a geographical area. Even further, the method according to the invention may provide a quantitative thickness distribution of a thin layer extending wider than a qualitative geographical thickness distribution according to the background art. A thinner, more realistic thin layer estimate may indicate less reservoir volume than for the prior art. A wider distribution of the thinner layer will indicate a larger reservoir extension and possibly also more connectivity between geographically distributed parts of the thin layer previously believed to be disjunct.

The following pages entitled “Thickness estimation from frequency response of thin layer” are hereby incorporated into the present specification.

### Thickness Estimation from Frequency Response of Thin Layer

### Espen Oen Lie

### Jun. 20, 2008

1 Introduction
In geophysics we are often interested in thickness of layers. This might be thickness of a potential reservoir or zone in reservoir. The common way to measure thickness, is by interpretation. That is picking top and base and calculate difference. This approach is however strongly suffering from an effect called tuning. That is that position of top and base in seismic are not corresponding to actual top and base when layer is thin. At which thickness this effect start to occur is dependent on frequency content.
In the following a technique that utilize this tuning effect to estimate true thickness is derived. On synthetic data it can be shown that the method is exact down to a noise floor where amplitude of reflection is at same level as background noise

2 Derivation of Thickness Inversion
We assume that we have seismic data of a thin layer in Fourier domain, that is a top and base reflection

d(ω)=W(ω)(rₜe^{iwt}^{ₜ}+r_{b}e^{iwt}^{_{b}}). (1)
where W is wavelet, r_{b} and rₜ are reflection coefficient at base and top of layer and t_{b} and tₜ are position of base and top (in twt). By introducing mean and difference measures

$$\begin{matrix}\overline{t} = {t}_{b} + {t}_{t} , {t}_{b} = \frac{1}{2} ( \overline{t} + Δ t ) & ( 2 ) \\ Δ t = {t}_{b} - {t}_{t} , {t}_{t} = \frac{1}{2} ( \overline{t} - Δ t ) & ( 3 ) \\ \overline{r} = {r}_{b} + {r}_{t} , {r}_{b} = \frac{1}{2} ( \overline{r} + Δ r ) & ( 4 ) \\ Δ r = {r}_{b} - {r}_{t} , {r}_{t} = \frac{1}{2} ( \overline{\overline{r}} - Δ r ) & ( 5 ) \\ & ( 6 )\end{matrix}$$

we get

$$\begin{matrix}d ( ω ) = W ( ω ) {e}^{i ω \frac{1}{2} \overline{t}} ( \begin{matrix}\frac{1}{2 } \overline{r} ( {e}^{i \frac{1}{2} ω Δ t} + {e}^{- i \frac{1}{2} ω Δ t} ) + \\ \frac{1}{2} Δ r ( {e}^{i \frac{1}{2} ω Δ t} - {e}^{- i ω \frac{1}{2} Δ t} )\end{matrix} ) & ( 7 ) \\ = W ( ω ) {e}^{i ω \frac{1}{2} \overline{t}} ( \begin{matrix}\overline{r} cos ( \frac{1}{2} ω Δ t ) + \\ i Δ r sin ( \frac{1}{2} ω Δ t )\end{matrix} ) & ( 8 )\end{matrix}$$

We can now look at the absolute value of this response.

$$\vert d ( ω ) \vert = \vert W ( ω ) \vert \vert \overline{r} cos ( \frac{1}{2} ω Δ t ) + i Δ r sin ( \frac{1}{2} ω Δ t ) \vert \qquad ( 9 )$$

This equation has two terms in addition to the wavelet spectrum. If we calculate the actual real valued terms for the trigonometric part we get

$$\vert d ( ω ) \vert = \vert W ( ω ) \vert \sqrt{{\overline{r}}^{2} {cos}^{2} ( \frac{1}{2} ω Δ t ) + Δ {r}^{2} {sin}^{2} ( \frac{1}{2} ω Δ t )} . \qquad ( 10 )$$

By rewriting the equation

$$\vert d ( ω ) \vert = \vert W ( ω ) \vert \vert Δ r \vert \sqrt{{sin}^{2} ( \frac{1}{2} ω Δ t ) + \frac{{\overline{r}}^{2}}{Δ {r}^{2}} {cos}^{2} ( \frac{1}{2} ω Δ t )} , \qquad ( 11 )$$

we see that if r̅²/Δr [symbol] 1, then

$$\vert d ( ω ) \vert \approx \vert W ( ω ) \vert \vert Δ r \vert \sqrt{{sin}^{2} ( \frac{1}{2} ω Δ t )} = \vert W ( ω ) \vert \vert Δ r sin ( \frac{1}{2} ω Δ t ) \vert \qquad ( 12 )$$

3 Solution to Inverse Problem
In equation (12) which states the problem, three terms enters: reflection strength, wavelet spectrum and thickness. Here we are primarily interested in thickness. And since it is a very simplified approach, we cannot expect to extract wavelet spectrum from this equation. Thus we want to estimate wavelet spectrum prior to this and cancel out Δr.
One approach that satisfies these criterias is optimizing correlation between synthetic model and real data. If we denotes the real data as d(ω) and synthetic data as dₛ(ω) the functional we are maximizing is

$$C ( Δ t ) = max \frac{< \vert {d}_{s} \vert , \vert d \vert {>}^{2}}{< \vert {d}_{s} \vert , \vert {d}_{s} \vert > < \vert d \vert , \vert d \vert >} \qquad ( 13 )$$

where |dₛ| and |d| has been equalized so that ∫|dₛ|dω=∫|d|dω=0. If our model is correct then the functional can be written as

$$\begin{matrix}C ( Δ {t}_{s} ) = \frac{\begin{matrix}{\vert Δ {r}_{s} \vert}^{2} {\vert Δ r \vert}^{2} \\ {( \int \vert {W}_{s} ( ω ) \vert \vert W ( ω ) \vert \vert sin ( \frac{1}{2} ω Δ {t}_{s} ) \vert \vert sin ( \frac{1}{2} ω Δ t ) \vert d ω )}^{2}\end{matrix}}{\begin{matrix}{\vert Δ {r}_{s} \vert}^{2} {\vert Δ r \vert}^{2} \int {\vert {W}_{s} ( ω ) \vert}^{2} {\vert sin ( \frac{1}{2} ω Δ {t}_{s} ) \vert}^{2} d ω \\ \int {\vert W ( ω ) \vert}^{2} {\vert sin ( \frac{1}{2} ω Δ t ) \vert}^{2} d ω\end{matrix}} & ( 14 ) \\ = \frac{{( \int \vert {W}_{s} ( ω ) \vert \vert W ( ω ) \vert \vert sin ( \frac{1}{2} ω Δ {t}_{s} ) \vert \vert sin ( \frac{1}{2} ω Δ t ) \vert d ω )}^{2}}{\begin{matrix}\int \vert {W}_{s} ( ω ) \vert {\vert sin ( \frac{1}{2} ω Δ {t}_{s} ) \vert}^{2} d ω \\ \int \vert W ( ω ) \vert {\vert sin ( \frac{1}{2} ω Δ t ) \vert}^{2} d ω\end{matrix} } & ( 15 )\end{matrix}$$

If wavelet spectrum is correct, then C(Δt)=1 and C(Δtₛ≠Δt)<1.

3.1 Estimation of Wavelet
Estimation of wavelet is actually not part of the method. However, this method demand less of the quality of wavelet than other inverse methods. First of all phase does not enter, only spectrum. Secondly amplitude is of no importance (it cancels out in method). We can still use a common well tie, but there is a simpler approach. If we assume that a trace consists of some reflections shaped by a wavelet, then

$$d ( ω ) = W ( ω ) {\sum }_{j} {r}_{j} {e}^{i ω t ,} . \qquad ( 16 )$$

If we then look at absolute values

$$\vert d ( ω ) \vert = \vert W ( ω ) \vert \vert {\sum }_{j} {r}_{j} {e}^{i ω {t}_{,}} \vert = \vert W ( ω ) \vert I ( {r}_{j} , {t}_{j} ) \qquad ( 17 )$$

where I(rⱼ, tⱼ) is the interference pattern for current trace. If we furthermore assume that this interference pattern is sufficiently different from trace to trace or we include enough traces outside the interesting area, then

$$W ( ω ) \approx \frac{1}{n} {\sum }_{k = 1}^{n} \vert W ( ω ) \vert I ( {r}_{j , k} , {t}_{j , k} ) \qquad ( 18 )$$

There are analytical models where one can prove the latter equation (reflection coefficients being gaussian and uniformly spaced), but these are usually not very realistic, so the approximation will be left mathematically unjustified.

3.2 Possible Failures
There are a lot of reasons for this approach to fail. The most important ones are the case where our data does not fit the model. That is, our data does not consist of a single top and base reflection. The three most important failures are
   1. Top/base reflector not being equally strong
   2. More high amplitude reflections in chosen window
   3. Incorrect wavelet
The first case where top and base are not equal is included in the derivation ((11)). This implies that there is an addition of a cosine term in spectrum. This is not serious in terms of optimizing the correlation, since it only reduce the maximum correlation, and not the maximum correlation thickness.
The second case is the serious one. If we have more higher amplitude reflections in window, than it is not easy to predict which pair of reflections that will give the highest correlation. For this reason the window used for thickness inversion should be so wide that it does not alter amplitude of interesting event, but not wider.
The case with incorrect wavelet, or more precise, incorrect wavelet spectrum. Results will be wrong. This, is most serious for small thicknesses where there are no notches in spectrum. For larger thicknesses this should not be that problematic, but larger thicknesses are not that interesting since they can be interpreted.

What is claimed is:

1. A method of estimating thickness of a geological layer, the method comprising the steps of:
(a) selecting seismic reflection field data from a subsurface depth interval of interest;
(b) providing a plurality of geological models having different layer thicknesses and providing respective model responses from the plurality of geological models;
(c) comparing a frequency spectrum of the seismic reflection field data with each of the frequency spectra of the model responses to derive comparison data associated with the different layer thicknesses of the models; and
(d) deriving from the comparison data a model layer thickness that is indicative of the thickness of the geological layer.

2. The method as claimed in claim 1, wherein step (c) further comprises the steps of correlating the frequency spectrum of the seismic reflection field data with each of the frequency spectra of the model responses, and deriving comparison data in the form of correlation values associated with each of the layer thicknesses of the models.

3. The method as claimed in claim 2, further comprising the steps of fitting a curve to the correlation values and deriving the model layer thickness indicative of the thickness of the geological layer from a value of the fitted curve.

4. The method as claimed in claim 1, wherein the step of comparing the frequency spectrum of the seismic reflection field data with each of the frequency spectra of the model responses is carried out in respect of the full frequency bandwidth.

5. The method as claimed in claim 1, wherein the frequency spectrum of the seismic reflection field data and the frequency spectra of the model responses take the form of power spectra.

6. The method as claimed in claim 1, further comprising the step of selecting a peak value of the comparison data and deriving the model layer thickness that is indicative of the thickness of the geological layer from the peak value.

7. The method as claimed in claim 1, further comprising the steps of selecting a maximum value of the comparison data, and deriving the model layer thickness that is indicative of the thickness of the geological layer deriving from the maximum value.

8. The method as claimed in claim 1, wherein the subsurface depth interval of interest contains the geological layer and the selected seismic data are associated with the geological layer.

9. The method as claimed in claim 1, wherein the selected seismic reflection field data are in the form of time series seismic data and the method includes the step of transforming the time series data to form the frequency spectrum of the seismic reflection field data.

10. The method as claimed in claim 1, further comprising the steps of forming the plurality of models and corresponding model responses iteratively and changing the thickness of the model layer in successive iterations.

11. The method as claimed in claim 1, further comprising the step of providing a plurality of models in which the layers have predetermined thicknesses.

12. The method as claimed in claim 1, wherein the models provided in step (b) differ solely by thickness of the model layer.

13. The method as claimed in claim 1, further comprising the step of setting one or more parameters of the model selected from the group comprising: acoustic impedance, reflectivity, depth, layer thickness, source waveform and source frequency.

14. A computer program adapted to control a computer to perform the method as claimed in claim 1.

15. A computer readable medium including computer readable instructions for performing the method as claimed in claim 1.

16. A method for quantitatively estimating a thickness of a buried geological layer, comprising the steps of:
using a seismic source having a source wavelet spectrum;
registering a seismic trace of reflection time domain data (5t);
selecting a temporal interval (t₁, t₂) of said trace of seismic reflection data (5t) producing a time interval series of seismic reflection data (5ts) for which a thickness (Δt or d) of said layer (L) in said temporal interval is to be determined;
transforming said time interval reflection data (5ts) into a seismic interval frequency spectrum (5f); and
repeating the following steps for a number of temporal thicknesses (Δt):
forming a model reflectivity spectrum (L_{mf}) representing a current temporal thickness (Δt) of a reflectivity function (Lₘₜ);
multiplying said model reflectivity spectrum (L_{mf}) with said source wavelet spectrum (3f), producing a thin layer model spectrum (Lₘₛ);
correlating said thin layer model spectrum (Lₘₛ) with said seismic interval frequency spectrum (5f) producing a (single) correlation value (C(Δt)) as function of the instant temporal thickness (Δt); and
selecting a peak value (C_{high}) in the so produced series of correlation values (C(Δt)) as function of the instant temporal thickness (C(Δt)), and letting the temporal thickness (Δt) corresponding to said peak value (C_{high}) indicate a thickness estimate (Lₘ) of said buried geological layer.

17. The method of claim 16, said reflectivity spectrum (L_{mf}) being a zero offset reflectivity spectrum representing a current temporal thickness (Δt) of a zero offset reflectivity function (Lₘₜ).

18. The method of claim 16, said seismic trace of reflection time domain data (5t) being a so-called near-offset stack of near offset seismic traces.

19. The method of claim 16, said seismic trace of reflection time domain data (5t) being a so-called intermediate-offset stack of intermediate offset seismic traces.

20. The method of claim 16, said seismic trace of reflection time domain data (5t) being a so-called far-offset stack of far offset seismic traces.

21. The method of claim 16, before the step of forming a model reflectivity spectrum (L_{mf}) representing a current temporal thickness (Δt) of a reflectivity function (Lₘₜ),
generating an acoustic impedance model with a layer (Lₘ) having an impedance contrast (Δz) and said temporal thickness (Δt), and forming said model reflectivity function (Lₘₜ) in time; and
transforming said model reflectivity function (Lₘₜ) into the frequency domain producing a model reflectivity spectrum (L_{mf}),

22. The method of claim 16, further comprising the steps of:
selecting a maximum value (Cₘₐₓ) among said peak values (C_{high}) of correlation values (C(Δt)) as function of the instant temporal thickness (C(Δt)); and
letting the temporal thickness (Δt) corresponding to said peak value (Cₘₐₓ) indicate said thickness estimate (Lₘ) of said buried geological layer (L).

23. The method of claim 16, further comprising the step of conducting the process for a number of seismic reflection traces (5t) registered in different geographical locations, to produce a thickness estimate (Lₘ) of said buried geological layer (L) for part or all of said geographical locations.

24. The method of claim 23, further comprising the step of registering the number of seismic reflection traces in a number of different geographical locations covering a seismic profile line section of the Earth.

25. The method of claim 23, further comprising the step of registering the number of seismic reflection traces in a number of different geographical locations covering a volume of the Earth.

26. The method of claim 16, further comprising the step of selecting said temporal interval (t₁, t₂) of said trace of seismic reflection data (5t) producing a time interval series of seismic reflection data (5ts) for which a thickness (d) of a layer in said temporal interval is to be determined, based on manually determining said temporal interval (t₁, t₂) from apparent reflections in said trace of seismic reflection data (5t).

27. The method of claim 16, further comprising the step of selecting said temporal interval (t₁, t₂) of said trace of seismic reflection data (5t) producing a time interval series of seismic reflection data (5ts) for which a thickness (d) of a layer in said temporal interval is to be determined, based on interpolating or extrapolating corresponding a temporal interval (t₁ₙ, t₂ₙ) comprising relevant reflections in one or more neighbour traces of seismic reflection data (5tₙ).

28. The method of claim 16, further comprising the step of producing the frequency domain source wavelet (3f) by measuring a source signature wavelet (3t) in the time domain, and transforming said source time domain wavelet (3t) into the frequency domain source wavelet (3f) by a Fourier transform.

29. The method of claim 16, further comprising the step of producing the frequency domain source wavelet (3f) by transforming one or more extensive seismic reflection traces into the into the frequency domain, thereby producing a source wavelet (3f).

30. The method of claim 16, said seismic trace of reflection time domain data (5t) being a trace registered on one single seismic sensor.

31. The method of claim 16, said seismic trace of reflection time domain data (5t) comprising traces registered on a multiplicity of seismic sensors and stacked to form said seismic trace of reflection time domain data (5t).

32. The method of claim 16, further comprising the step of varying said temporal interval (t₁, t₂) over a geographical area in order to pick up a thin layer of which the depth to top and bottom varies over the geographical area.

33. The method of claim 16, in the step of generating an acoustic impedance model with a layer (Lₘ) having an impedance contrast (Δz) and said temporal thickness (Δt), and forming a model reflectivity function (Lₘₜ) in time, introducing within said temporal interval (t₁, t₂) other empirical impedance contrasts and temporal thicknesses for layers ahead of or after said layer (Lₘ).
